(19) United States
(12) Patent Application Publication
(10) Pub. No.: US 2005/0175099 A1
(43) Pub. Date: Aug. 11, 2005

(54) Transcoder and associated system, method and computer program product for low-complexity reduced resolution transcoding

(75) Inventors: Juha Sarkijarvi, Tampere (FI); Ville Lappalainen, Tampere (FI); Petri Liuha, Tampere (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/774,263

(22) Filed: Feb. 6, 2004

(51) Int. Cl. H04N 7/12

(52) U.S. Cl. 375/240.16; 375/240.24; 375/240.21; 375/240.2; 375/240.03; 375/240.23

(57) ABSTRACT

A transcoder is provided for transcoding data comprising a group of macroblocks representing a frame of data, where the frame of data can include a plurality of sample lines each having a plurality of samples. The transcoder includes a decoder capable of decoding input data to thereby generate prediction error and decoded image data in the spatial domain. The transcoder also includes a downsampler capable of downsampling the prediction error or the decoded image data in a first (e.g., horizontal) direction and/or a second (e.g., vertical) direction different than the first direction to generate a downsampled macroblock in the spatial domain. In addition, the transcoder includes an encoder. The encoder, then, is capable of encoding the downsampled macroblock into output data.

### FIELD OF THE INVENTION

The present invention generally relates to systems and methods for reduced resolution transcoding and, more particularly, to systems, methods and computer program products for low-complexity reduced spatial resolution transcoding.

### BACKGROUND OF THE INVENTION

Video encoding systems are known in which an image to be encoded is divided into blocks. These blocks are then encoded and transmitted to a decoding device or stored into a storage medium. For reducing the amount of information to be transmitted, different compression methods have been developed, such as MPEG-2 (Motion Picture Experts Group), MPEG-4, H.261, H.263, H.264 or the like. In the transmission of video images, image compression can be performed either as interframe compression, intraframe compression, or a combination of these. In interframe compression, the aim is to eliminate redundant information in successive image frames. Typically, images contain a large amount of such non-varying information, for example a motionless background, or slowly changing information, for example when the object moves slowly.

In interframe compression, it is also possible to utilize motion compensation, wherein the aim is to detect such larger elements in the image which are moving, wherein the motion vector and some kind of difference information of this entity are transmitted instead of transmitting the samples representing the whole entity. Thus, the direction of the motion and the speed of the subject in question are defined, to establish this motion vector. For compression, the transmitting and the receiving video terminals are required to have such a high processing rate that it is possible to perform compression and decompression in real time.

In video compression, an image is typically partitioned into macroblocks and macroblocks are further divided into blocks. Usually, a macroblock consists of one 16×16 array of luminance samples and two arrays of chrominance samples. Chrominance is typically sampled at a lower resolution than luminance, since the eye does not discern changes in chrominance equally well as changes in luminance. In a typical case, the chrominance resolution is half of luminance resolution in both horizontal and vertical directions, but it should be noted that some video compression standards also support sampling chrominance at the same resolution as luminance (16×16 samples). Thus, a chrominance array consists of an 8×8 samples. In this case, a macroblock is divided into six 8×8 blocks so that four of the blocks derive from the luminance sample array, and two of the blocks derive from chrominance sample arrays.

Many conventional video compression standards operate on macroblock basis. Typically, motion estimation is performed to find a prediction for a macroblock from one or more previously coded frames. If motion estimation cannot find sufficient prediction for the macroblock, the macroblock is coded in intra-mode. In such instances, the sample data of the macroblock can be transformed, quantized and variable-length coded. If the motion estimation can find sufficient prediction, however, motion information is represented as motion vector(s), and the macroblock is coded in an inter-mode. In this case, motion compensation is performed to form a prediction for the macroblock from the sample data of previously coded frame(s). After that, the difference between the current macroblock and the prediction, often referred to as the prediction error, is computed. The prediction error can thereafter be transformed, such as by Discrete Cosine Transform (DCT), quantized and finally variable-length coded (VLC) into the compressed bit stream. In addition, the motion vectors and macroblock mode information can be variable-length coded into the compressed bit stream.

For inter-coded macroblocks, then, at least one motion vector is utilized. In this regard, a number of compression standards allow several motion vectors for each macroblock. For example, in MPEG-4 compression, four motion vectors can be utilized in a macroblock; one motion vector for each luminance block. In such instances, the motion vector for chrominance component can be determined from four luminance motion vectors. In MPEG-2 compression, on the other hand, two motion vectors can be utilized; one motion vector for each interlaced field of a macroblock. For more detailed information on video compression algorithms and standards, see Bhaskaran et al., IMAGE AND VIDEO COMPRESSION STANDARDS, ALGORITHMS AND ARCHITECTURES (1995).

As will be appreciated, during transmission of video from one device to another it can often be advantageous to convert data encoded in one format into data encoded into another format. In other terms, it can often be advantageous to transcode data from one format into another format. Although data can be transcoded in a number of different manners, data such as video is typically transcoded to reduce the bit rate of the data. As mobile devices such as mobile telephones, portable digital assistants (PDAs), pagers, and laptop computers have come into prominence, it has become desirable to transcode video data to reduce spatial resolution.

Video data can be transcoded in any of a number of different manners. In one typical situation, for example, data is transcoded to reduce the bit rate of the data, such as to meet the capacity of a channel over which the data is transmitted. In this regard, as shown in FIG. 1, one of the most straightforward transcoders 10 for transcoding data from one bit rate to another includes a cascading decoder 12, downsampler 14 and encoder 16. Generally, in operation, input data encoded at one bit rate can be received into the decoder, which decodes the input data. The downsampler, in turn, downsamples the decoded data, such as by a factor of two. Downsampling can be performed to reduce either spatial or temporal resolution or both. The downsampled data can then be re-encoded by the encoder at a reduced bit rate.

Cascading transcoders, such as the cascading transcoder 10 shown in FIG. 1 can be advantageous in that such transcoders are capable of transcoding video, while achieving the best visual quality of the video at a given bit rate. Cascading transcoders, however, can impose high computational requirements in systems utilizing such transcoders. As such, cascading transcoding techniques are typically impractical for many applications. To reduce the computational requirements in transcoding data from one bit rate to another, and to further provide spatial resolution reduction, open-loop transcoders have been developed. One such transcoder is described in U.S. Pat. No. 6,671,322, entitled: Video Transcoder with Spatial Resolution Reduction, issued Dec. 30, 2003 to Vetro et al., the contents of which are hereby incorporated by reference in its entirety. As shown in FIG. 2, as disclosed by the Vetro '322 patent, the open-loop transcoder 18 receives input data, after which a variable-length decoder (VLD) 20 decodes the input data to generate quantized DCT coefficients, and full-resolution motion vectors. The full-resolution motion vectors can then be mapped by a MV mapping element 22 into reduced-resolution motion vectors. The quantized DCT coefficients, on the other hand, can be passed through an inverse quantizer (Q⁻¹) 24 to generate the DCT coefficients.

The DCT coefficients can then be received by a mixed block processor 26. As will be appreciated, in MPEG encoding techniques, intra (I)-frames include macroblocks coded only according to an intra-mode. Predicted (P)-frames, on the other hand, can include macroblocks coded according to the intra-mode and/or an inter-mode. However, mixed coding modes inside a macroblock are not supported by conventional video coding techniques. These techniques typically require that all of the blocks of a macroblock must be in the same coding mode. A problem may arise in reduced resolution transcoding when, for example, four original resolution macroblocks are converted into one reduced resolution macroblock. If the four original macroblocks are coded in different modes, then the blocks of the resulting macroblock shall also contain different modes. This situation is not supported in conventional video coding techniques. As such, the mixed block processor is capable of converting one or more of the original macroblocks from one coding mode to another.

In accordance with one technique for converting one or more macroblocks from one coding mode to another, sometimes referred to as ZeroOut, the mixed block processor can convert the original intra-coded macroblocks into inter-coded macroblocks by simply replacing intra-DCT-coefficients with zeros. In accordance with another technique, sometimes referred to as IntraInter, the mixed block processor is likewise capable of converting intra-coded macroblocks into inter-coded macroblocks, but the motion vectors for the intra-coded macroblocks are also predicted. Also, in accordance with yet another technique, sometimes referred to as InterIntra, the mixed-block processor is capable of converting the original inter-coded macroblocks to intra-coded macroblocks. As will be appreciated by those skilled in the art, although the mixed block processor is capable of operating in accordance with any of the above techniques, the open-loop transcoder 18 further includes a motion compensation (MC) loop (except in ZeroOut technique) to reconstruct a full-resolution image, which can be used as a reference in converting DCT coefficients from intra-to-inter or inter-to-intra.

Irrespective of the technique used to process mixed blocks, the output of the mixed block processor 26 can pass through a downsampler 28 capable of downsampling the data, such as by downsampling the DCT coefficients of four original macroblocks into the DCT coefficients of one reduced-resolution macroblock. The downsampled DCT coefficients can then be quantized by a quantizer 30. Thereafter, the quantized output can be variable-length encoded by a variable-length encoder (VLC) 32.

As indicated above, in open-loop transcoders such as the open-loop transcoder 18 shown in FIG. 2, a mixed block processor 26 can convert intra-coded macroblocks into inter-coded or vice versa. As will be appreciated, however, such a conversion is only a very rough approximation and can result in severe visual errors that drift from one P-frame to another P-frame. Thus, like cascading transcoders, such open-loop transcoders are also typically impractical for many applications. To overcome the drawbacks of the open-loop transcoder of FIG. 2, an intra-refresh transcoder has been developed that is based on the open-loop transcoder, but avoids severe visual errors. Such a technique is disclosed in Yin et al., Drift Compensation for Reduced Spatial Resolution Transcoding, IEEE TRANSACTIONS ON CIRCUITS AND SYSTEMS FOR VIDEO TECHNOLOGY, vol. 12, no. 11, 1009-1020 (2002), the contents of which are hereby incorporated by reference in its entirety.

As shown in FIG. 3, a typical intra-refresh transcoder 34 incorporates a full-resolution decoder 36 in an open-loop transcoder architecture to thereby permit the mixed block converter 26 to operate in accordance with the InterIntra technique for converting the one or more inter-coded macroblocks to intra-coded macroblocks. The full-resolution decoder includes a VLD 20, Q⁻¹ 24, inverse DCT coder (IDCT) 38, motion compensator (MC) 40, summing element 42 and frame store 44, which can collectively fully decode and store the incoming data in the spatial domain. In accordance with the intra-fresh technique, then, the DCT coefficients of macroblocks from input data are subject to a DCT-domain downsampling (in downsampler 28), requantization (in quantizer 30) and variable-length coding (in VLC 32). However, in lieu of deriving the output macroblocks directly from the input data through the VLD 20, Q⁻¹ 24 and mixed block converter 26, one or more of the output macroblocks can be derived from the frame store of the full-resolution decoder 36. In this regard, the spatial domain data stored in the frame store can be DCT-coded in a DCT coder 46 and supplied to the mixed block converter as intra-coded macroblocks. And as will be appreciated, intra-coded macroblocks are not subject to drift error.

In the intra-fresh transcoder 34, the decision to convert inter-coded macroblocks to intra-coded macroblocks typically depends on the macroblock coding modes and image statistics. More particularly, the macroblock can be converted from an inter-code to an intra-code when a mixed block situation is detected, or when the macroblock is found to be likely to contribute to a larger drift error. As will be appreciated, however, altering the number of intra-coded macroblocks requires an adjustment in the bit rate of the output data since intra-coded macroblocks typically require more bits to code. Thus, the intra-refresh transcoder 34 typically also includes a rate control element 48 capable of adjusting the quantization parameters such that the target bit rate can be more accurately achieved.

Whereas a transcoder such as the intra-refresh transcoder 34 is computationally considerably less complex than the cascaded transcoder 10, it may still have too high complexity for processors, such as those of mobile terminals, that have limited processing and/or memory capacities. Thus, it would be desirable to design a system, method and computer program product for transcoding data in a manner that requires less processing and memory resources than the intra-refresh transcoder 34, while maintaining an acceptable visual quality of the output video.

### SUMMARY OF THE INVENTION

In light of the foregoing background, embodiments of the present invention provide an improved transcoder and associated system, method and computer program product for transcoding data. In accordance with embodiments of the present invention, the transcoder generally includes a decoder, an element that for a group of macroblocks passes either decoded image data or a prediction error (in spatial domain), downsampler and an encoder. In one advantageous embodiment the transcoder includes a reduced-resolution decoder to achieve low computational complexity. It should be understood, however, that the decoder can comprise a full-resolution decoder.

The transcoder is capable of transcoding video data in a manner requiring less processing and memory capacity than conventional transcoding techniques, including the intra-refresh technique. More particularly, as explained below, the transcoder is capable of transcoding data quicker than the intra-refresh transcoder as the transcoder of embodiments of the present invention does not include DCT-domain down sampling. Further, because the transcoder does not include DCT-domain downsampling, the transcoder is simpler to implement than a number of conventional transcoders, including the intra-refresh transcoder. In addition, the transcoder is capable of more quickly transcoding data because the transcoder can perform decoding in reduced resolution. In this regard, because frame buffers for reduced resolution decoding need a reduced amount of memory than that required for full resolution decoding, the transcoder of embodiments of the present invention requires less memory capacity than conventional transcoders.

According to one aspect of the present invention, a transcoder is provided for transcoding data comprising a group of macroblocks representing a frame of data. The transcoder includes a decoder capable of decoding input data to thereby generate prediction error and decoded image data in the spatial domain. More particularly, for example, the decoder can include a variable-length decoder, an inverse quantizer, an inverse Discrete Cosine Transform (DCT)-coder and a summing element. In this regard, the variable-length decoder can be capable of variable-length decoding input data to generate quantized DCT coefficients. In turn, the inverse quantizer can be capable of inverse quantizing the quantized DCT coefficients to generate DCT coefficients. The inverse DCT-coder can be capable of inverse DCT-coding the DCT coefficients to generate the prediction error in the spatial domain. The summing element can then be capable of summing the prediction error and motion compensation data to generate the decoded image data.

In addition to the decoder, the transcoder can include a mixed block processor, referred to herein as an intra/inter selector. The intra/inter selector can be capable of passing the decoded image data or the prediction error for a group of macroblocks, both having been generated by the decoder. In this regard, the group of macroblocks can include those macroblocks that are subsequently downsampled into one macroblock and encoded, as explained below. Generally, when intra-mode is used at the encoding, the intra/inter selector can pass the decoded image data for the group of macroblocks; otherwise, the intra/inter selector can pass the prediction error. In this regard, of the coding mode (intra or inter) can be selected based upon the coding mode, motion vectors, the residual energy (the amount of prediction error) of the group of macroblocks, for example. More particularly, for example, intra mode coding can be selected if at least one of the original macroblocks in the group of macroblocks has been coded in intra mode. In addition, for example, the coding mode can be selected based upon feedback from a rate control.

In addition to the decoder and the intra/inter selector, the transcoder can include a downsampler capable of downsampling the spatial domain output of the intra/inter selector, i.e., the prediction error or the decoded image data. The downsampler can downsample the image data (or spatial domain prediction error) of a group of macroblocks into image data (or spatial domain prediction error) of one macroblock. The downsampler can downsample the image data (or spatial domain prediction error) in accordance with any of a number of techniques, such as by skipping samples or averaging neighboring samples. For interlaced content, for example, downsampling can be done by skipping one of the interlaced fields (top or bottom).

As explained below, the downsampler can downsample data in a simplified manner (or in some cases completely removed), when the transcoder comprises a reduced resolution decoder. For example, when transcoding interlaced content, such as interlaced MPEG-2, 4CIF (common intermediate format) resolution content, into half-resolution progressive video content, such as MPEG-4 simple profile, CIF resolution content, it may be advantageous to perform reduced-resolution decoding so that downsampling in a first (e.g., horizontal) direction is embedded into the decoding process. In this case, the downsampler can downsample data in only a second (e.g., vertical) direction.

The transcoder can also include a motion vector mapping element capable of mapping the motion vectors of a group of macroblocks into motion vector(s) of one macroblock to be encoded, if inter mode is selected in the intra/inter selector. Further, the transcoder can include an encoder capable of encoding macroblocks in the intra or inter mode. If inter-mode is selected, motion vectors can be received from the motion vector mapping element, and the prediction error of the macroblock can be received from the intra/inter selector and downsampler. If intra-mode is selected, however, the image data of the macroblock can be received from the intra/inter selector and downsampler. More particularly, for example, the encoder can include a DCT-coder, a quantizer and a variable-length encoder. In this regard, the DCT-coder can be capable of DCT-coding the data that is available at the output of the downsampler (downsampled prediction error or decoded image data). The quantizer can then be capable of quantizing the DCT coefficients. Thereafter, the variable-length encoder can be capable of variable-length coding the DCT coefficients, as well as macroblock mode information and motion vectors, into output data.

In accordance with another aspect of the present invention, a transcoder for transcoding generally includes a reduced-resolution decoder, a downsampler and an encoder. The decoder is capable of decoding input data to thereby generate decoded image data at a reduced resolution and downsample the input data in a first (e.g., horizontal) direction. The downsampler, in turn, is capable of downsampling the decoded image data in a second (e.g., vertical) direction. The encoder, thereafter, is capable of encoding the downsampled macroblock into output data. In a manner similar to that indicated above and explained below, the decoder can be capable of decoding input data to thereby generate the decoded image data and a prediction error, both in the spatial domain. In such instances, the downsampler can be capable of downsampling the prediction error or the decoded image data to generate the downsampled macroblock. To select between the prediction error and the decoded image data, the transcoder can include an intra/inter selector. Alternatively, the transcoder can include a mixed block processor capable of converting at least one of the macroblocks of the decoded image data from a first coding mode (e.g., inter-coding or intra-coding) to a second coding mode (e.g., intra-coding or inter-coding) before the downsampler downsamples the decoded image data.

According to other aspects of the present invention, a terminal, method and computer program product are provided for transcoding data. Therefore, embodiments of the present invention provide a transcoder and associated system, method and computer program product for transcoding data, particularly video data. The transcoder and associated system, method and computer program product of embodiments of the present invention are capable of transcoding data in a manner requiring less processing and memory capacity than conventional transcoding techniques, including the intra-refresh technique. In this regard, the transcoder and associated system, method and computer program product of embodiments of the present invention do not include DCT-domain down sampling, and are capable of decoding data with a reduced resolution. Therefore, the transcoder and associated system, method and computer program product of embodiments of the present invention are especially suitable when low complexity is appreciated.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a well-known cascading transcoder;

FIG. 2 is a schematic block diagram of a well-known open-loop transcoder;

FIG. 3 is a schematic block diagram of a well-known intra-refresh transcoder;

FIG. 4 is a schematic block diagram of a transcoder in accordance with one embodiment of the present invention;

FIG. 5 is a flowchart illustrating various steps in a method of transcoding data in accordance with embodiments of the present invention;

FIG. 6 is a schematic block diagram of a transcoder in accordance with another embodiment of the present invention;

FIG. 7 is a schematic block diagram of a transcoder in accordance with yet another embodiment of the present invention;

FIG. 8 is a schematic block diagram of a wireless communications system according to one embodiment of the present invention including a mobile network and a data network to which a terminal is bi-directionally coupled through wireless RF links;

FIG. 9 is a schematic block diagram of an entity capable of operating as a terminal, origin server, digital broadcast receiving terminal and/or a digital broadcaster, in accordance with embodiments of the present invention;

FIG. 10 is a functional block diagram of a digital broadcast receiving terminal, in accordance with one embodiment of the present invention;

FIG. 11 is a functional block diagram of the digital broadcaster, in accordance with one embodiment of the present invention; and

FIG. 12 is a schematic block diagram of a mobile station that may operate as a terminal, according to embodiments of the present invention.

### DETAILED DESCRIPTION OF THE INVENTION

The present invention now will be described more fully hereinafter with reference to the accompanying drawings, in which preferred embodiments of the invention are shown. An interlaced MPEG-2 to progressive MPEG-4 reduced resolution transcoder is described in detail to show an example how invention can be utilized. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

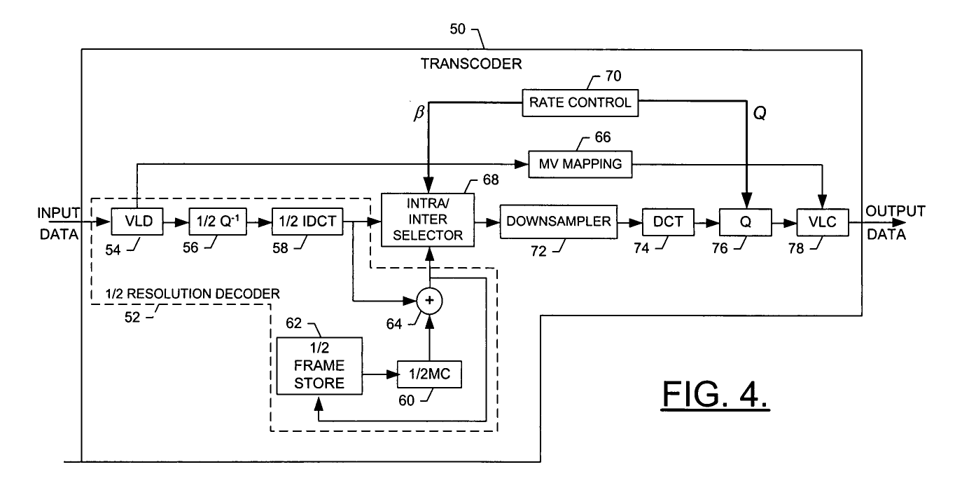

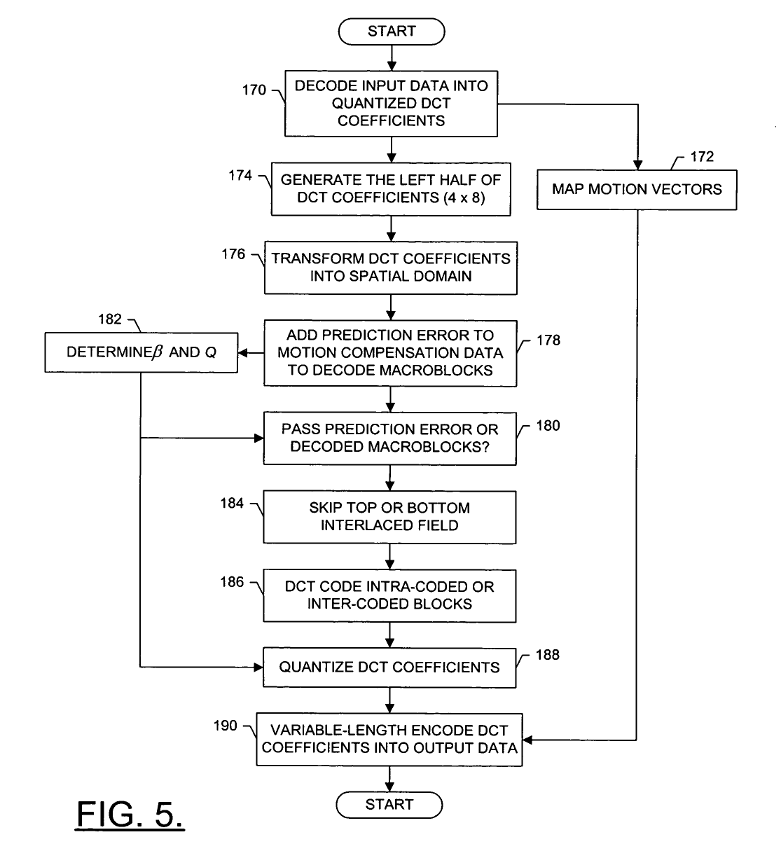

Referring to FIGS. 4 and 5, a transcoder 50 and method of transcoding data, respectively, are shown in accordance with embodiments of the present invention. Generally, the transcoder of embodiments of the present invention includes a reduced resolution decoder 52, an intra/inter selector 68, downsampler 72, a motion vector (MV) mapping element 66 and an encoder. The reduced resolution decoder is capable of decoding video, such as at one-half resolution. The reduced resolution decoder can include a variable-length decoder (VLD) 54, a half-resolution inverse quantizer (½ Q⁻¹) 56, inverse DCT coder (½ IDCT) 58, motion compensator (½ MC) 60 and frame store (½ FRAME STORE) 62. In addition, the reduced resolution decoder can include a summing element 64.

As is well known, the variable-length decoder 54 can be capable of decoding input data to generate quantized DCT coefficients, and full-resolution motion vectors, as shown in block 170 of FIG. 5. In this regard, the input data can comprise, for example, interlaced MPEG-2 encoded data. It should be understood, however, that the input data can comprise non-interlaced MPEG-2 encoded data. Also, it should be understood that the input data can comprise data encoded in accordance with any of a number of other techniques. After the variable-length decoder decodes the input data, the full-resolution motion vectors can then be mapped by a motion vector mapping element 66 into reduced-resolution motion vectors, as shown in block 172. The quantized DCT coefficients, however, can be passed to the half-resolution inverse quantizer 56, which can process the left half of quantized DCT coefficients to generate the left half of DCT coefficients, as shown in block 174. As indicated above in the background section, DCT coefficients in MPEG-2 encoded video data represent blocks of 8×8 samples. As will be appreciated, however, the low frequency DCT coefficients are typically considered to preserve most of the energy of the video data. Thus, the inverse quantizer can be configured to only inverse quantize the DCT coefficients for the left half of DCT coefficient block (4×8) to generate the DCT coefficients at half resolution. Since such quantization can preserve all of the low frequencies, and since the energy in high frequency DCT coefficients are low for most residual errors, no artifacts are typically visually noticeable even after obtaining an upsampled image from a down sampled image. And as will be appreciated, by only inverse quantizing and processing the left half of DCT coefficient block (4×8), the reduced resolution decoder effectively downsamples the video data in the horizontal direction.

From the half-resolution inverse quantizer 56 of the reduced-resolution decoder 52, the half-resolution DCT coefficients can pass through the inverse DCT coder 58, which is capable of transforming the DCT coefficients from the DCT domain to the spatial domain, as shown in block 176. More particularly, for example, the inverse DCT coder can comprise a 4×8 inverse DCT coder capable of generating, from the DCT coefficients from the half-resolution inverse quantizer, a 4×8 block or prediction error (i.e., residual block) in the spatial domain. Then, as shown in block 178, the prediction error can be added, in the summing element 64, with motion compensation data from the half-resolution motion compensator 60 to thereby decode the macroblocks into decoded image data. In this regard, the half-resolution motion compensator can comprise a 8×16 motion compensator, for example. In this regard, the motion compensator can receive a previously decoded low-resolution version of a video frame from the frame store 62. Utilizing the previously decoded low-resolution version of the video frame as a reference frame, then, the motion vectors can be scaled down by a factor of two. To support motion compensation with half-sample accuracy in full-resolution of a video frame, the motion compensator can generate quarter sample values in accordance with, e.g., a bi-linear interpolation or a nearest neighborhood interpolation technique. For more information on portions of such a half-resolution decoder, see Yeo et al., Issues in Reduced-Resolution Decoding of MPEG Video, INT'L CONFERENCE ON IMAGE PROCESSING (ICIP), vol. 2, 5-8 (2002), the contents of which are hereby incorporated by reference in its entirety.

As also shown in FIG. 4, the transcoder 50 includes a mixed block converter capable of operating in accordance with the InterIntra technique for converting the one or more inter-coded macroblocks to intra-coded macroblocks. Thus, as shown, the mixed block converter is referred to as an intra/inter selector 68. As shown, the intra/inter selector is capable of receiving decoded macroblocks of video data in the spatial domain from the reduced resolution decoder 52, or more particularly the summing element 64 of the reduced resolution decoder. In addition, the intra/inter selector is capable of receiving the prediction error in the spatial domain for the same blocks from the half-resolution inverse DCT coder 58 of the reduced resolution decoder. In accordance with embodiments of the present invention, for each macroblock, the intra/inter selector is capable of determining whether to pass the prediction error or the decoded image data for a group of macroblocks, and thereafter passing either the prediction error or the decoded image data based upon the determination, as shown in block 180.

The intra/inter selector 68 can determine whether to pass the prediction error or the decoded image data for a group of macroblocks in accordance with any of a number of different techniques. Generally, since the inter-coded macroblocks are subject to drift error, the intra/inter selector can determine that intra-mode is used at the encoding, and pass the decoded image data for the group of macroblocks in instances when one of the original macroblocks is coded in intra mode or there is an indication that an inter-coded macroblock may cause large drift error. More particularly, in reduced resolution transcoding interlaced MPEG-2 to progressive MPEG-4, for example, the intralinter selector can pass the decoded image data if (a) at least one of the four original macroblocks of the frame comprises an intra-coded macroblock, (b) at least one of the four original macroblocks utilizes a field motion compensation mode of the encoding scheme of the video data, (c) the residual energy (amount of energy in DCT coefficients corresponding to prediction error) of at least one of the four original macroblocks is greater than a first threshold (e.g., 100,000), (d) at least one of the original motion vectors is greater than a second threshold (longer motion vectors being indicative of increased drift error), (e) at least one of the original motion vectors differs from the average of original motion vectors more than a third threshold, (f) a macroblock at a certain location has been coded as inter-macroblock more than a predefined number of consecutive times, or (g) a rate control element 70 of the transcoder otherwise instructs the intra/inter selector as to the percentage of intra-coded macroblocks to pass, as explained below.

As will be appreciated, the first, second and third thresholds can be selected in any of a number of different manners. For example, the thresholds can be selected based upon subjective and/or objective evaluations of visual quality of the output, transcoded video data. In this regard, the thresholds affect the number of intra-coded macroblocks, and consequently, the bit rate of the output video. Thus, the thresholds can be selected to thereby achieve a desired tradeoff between bit rate and visual quality. As will also be appreciated, although the various thresholds can comprise predetermined values, it should be understood that, during operation of the intra/inter selector, one or more of the thresholds can be dynamically adjusted by the bit rate of the output data and/or desired video quality.

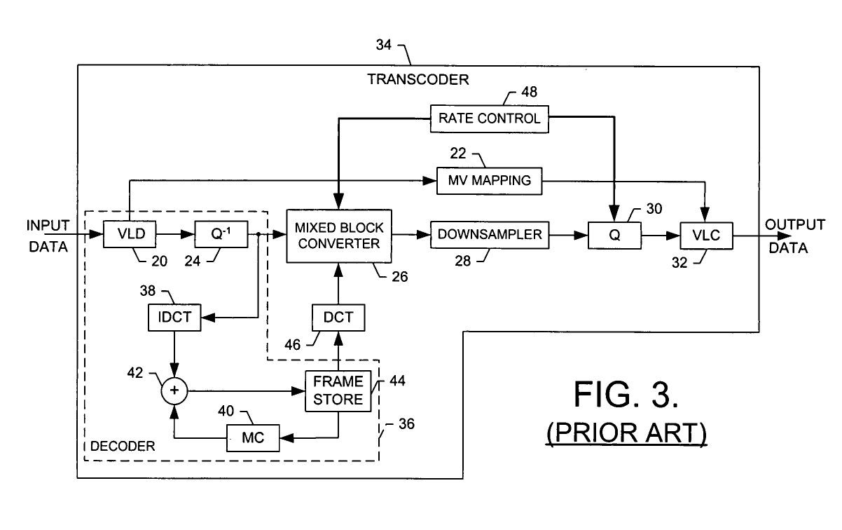

One technique that can be utilized by the rate control element 70 to decide whether to instruct the intra/inter 68 to pass the prediction error or the decoded image data is the intra-refresh technique disclosed in Yin et al., Drift Compensation for Reduced Spatial Resolution Transcoding, IEEE TRANSACTIONS ON CIRCUITS AND SYSTEMS FOR VIDEO TECHNOLOGY, vol. 12, no. 11, 1009-1020 (2002). In accordance with this technique, a rate control element can estimate drift error in the encoded input data stream, and thereafter translate the estimated drift error into an intra-refresh rate, β, that can be passed to the intra/inter selector to instruct the intra/inter selector as to the percentage of intra-coded macroblocks in a frame of data, as shown in block 182. The drift error can be estimated based upon data representative of an amount of motion vector truncation, residue energy in the data and/or motion activity. As indicated above in the background section with respect to intra-refresh transcoders 34 (see FIG. 3), altering the number of intra-coded macroblocks requires an adjustment in the bit rate of the output data since intra-coded macroblocks typically require more bits to code. Thus, the rate control element 48 is capable of adjusting the quantization parameter, Q, such that the target bit rate can be more accurately achieved, as also shown in block 182.

In accordance with the intra-refresh rate, β, the intra/inter selector 68 can determine the inter-coded macroblocks to convert into intra-coded macroblocks, or more particularly, determine to pass the prediction error, in accordance with an adaptive intra-refresh (AIR) technique. In this regard, in accordance with the AIR technique, the intra/inter selector can determine to pass the prediction error if (a) the sum of residue energy of a group of four macroblocks exceeds a threshold, T_{SRE}, or (b) the sum of motion vector variance of the group of macroblocks exceeds a threshold, T_{SMV}. Both thresholds can be initially set at default values (e.g., T_{SRE}=100,000; T_{SMV}=6,000). During operation of the intra/inter selector, however, one or both of the thresholds can be dynamically adjusted by the bit rate of the output data and/or desired video quality. For example, if the difference between target bit rate and the output bit rate is positive, implying that the target quality is higher than the bits that have actually been spent, the intra/inter selector can decrease the thresholds; otherwise, the intra/inter selector can increase the thresholds.

As indicated above, by only inverse quantizing and processing the left half of DCT coefficient block (4×8), the reduced resolution decoder 52 effectively downsamples the video data in the horizontal direction. Thus, the transcoder 50 need only downsample or downscale the video data in the vertical direction to fully downsample the video data. From the intra/inter selector 68, then, the prediction error or decoded image data can pass through a downsampler 72 capable of vertically downsampling the prediction error or decoded image data into a downsampled macroblock. For example, the downsampler can be capable of vertically downsampling the prediction error or decoded image data by skipping the top or bottom interlaced field of a frame of video data, as shown in block 184. In this regard, the downsampler can skip the chosen interlaced field in any of a number of different manners, such as by requisite memory addressing during implementation of the transcoder. Alternatively, when the video data comprises non-interlaced video data, the downsampler can skip every other sample line of a frame of video data (or alternatively average two consecutive sample lines). As can be seen, then, by horizontally downsampling the video data in the reduced resolution decoder and vertically downsampling the video data in the downsampler, the transcoder of embodiments of the present invention need not include a DCT-domain downsampling element, in contrast to the intra-refresh transcoder 34 (see FIG. 3).

The downsampled macroblock output of the downsampler 72 can be passed through a DCT coder 74 capable of DCT-coding the intra-coded or inter-coded blocks of the resulting macroblock back into DCT coefficients in the DCT domain, as shown in block 186. Thereafter, as shown in block 188, the DCT coefficients can be quantized by a quantizer 76, which is capable of receiving quantization parameters from the rate control element 70. The quantized output can then be variable-length encoded by a variable-length encoder (VLC) 32, which is also capable of receiving the mapped motion vectors from the motion vector mapping element 66, as shown in block 190. In this regard, the variable-length encoder can encode the quantized output and mapped motion vectors into output data in any of a number of different formats including, for example, MPEG-4, H.261, H.263, H.264 or the like.

As explained above, the transcoder 50 includes a reduced resolution decoder 52 capable of decoding video at a reduced (e.g., one-half) resolution. It should be understood, however, that the transcoder can alternatively include a full-resolution decoder without departing from the spirit and scope of the present invention. In such instances, the downsampler 72 can be further capable of horizontally downsampling the prediction error or decoded image data, such as by skipping every other sample of each sample line of a frame of video data, or by averaging every pair of neighboring samples of each sample line of a frame of video data.

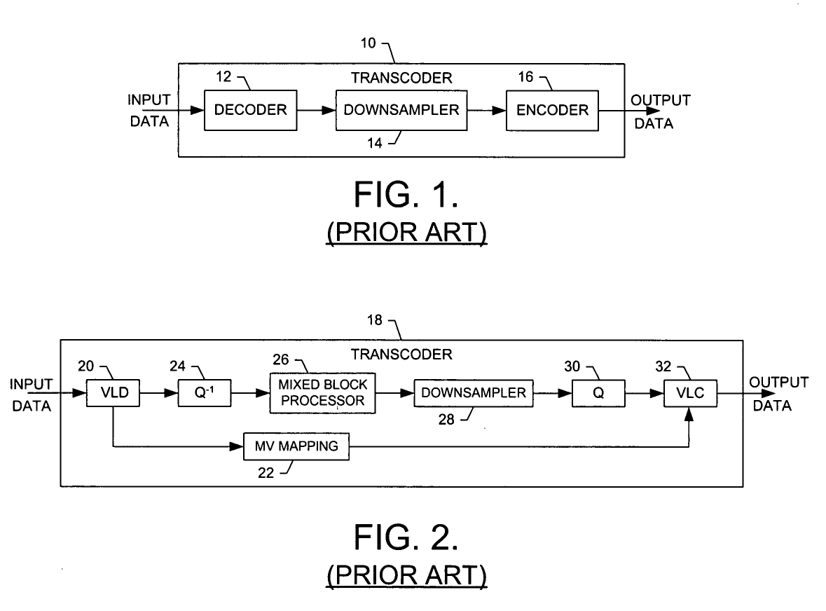

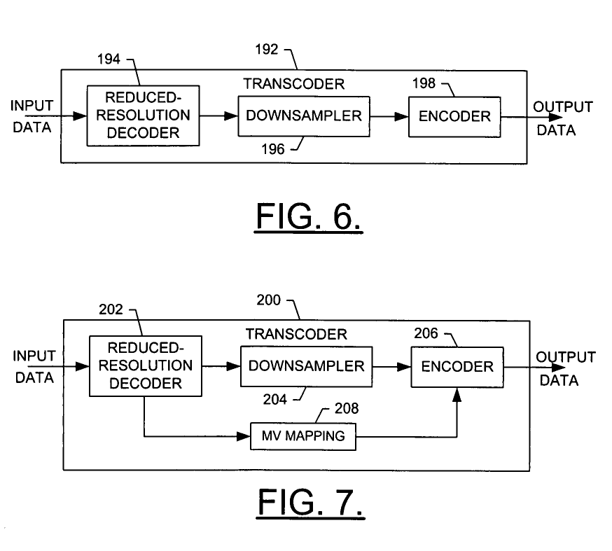

As also explained above, the transcoder 50 can include a mixed block processor comprising an intra/inter 68, which can determine to pass the residual blocks or the decoded macroblocks in accordance with the intra-refresh technique, for example. It should be understood, however, that the transcoder of embodiments of the present invention, including the reduced-resolution decoder 52 and downsampler 72, can generally be configured to operate in accordance with any of a number of different transcoding techniques. For example, as shown in FIG. 6, a transcoder 192 of an alternative embodiment of the present invention can be configured in a cascading transcoder arrangement (see FIG. 1). In this regard, the transcoder of this embodiment can include a reduced-resolution (e.g., one-half resolution) decoder 194, a downsampler 196 and an encoder 198.

The reduced-resolution decoder 194 of the transcoder 192 of FIG. 6 can comprise a decoder such as the reduced-resolution decoder 52 illustrated in FIG. 4. In operation, then, the reduced-resolution decoder is capable of receiving input video data, decoding the video data at a reduced resolution, and outputting decoded macroblocks of video data in the spatial domain. And like the reduced-resolution decoder of the transcoder 50 of FIG. 4, the reduced-resolution decoder of the transcoder of FIG. 6 can also be capable of effectively downsampling the video data in the horizontal direction. The downsampler 196 of the transcoder of FIG. 6, then, can be capable of vertically downsampling the decoded macroblocks, such as in a manner similar to the downsampler 72 of the transcoder of FIG. 4. The horizontal and vertical downsampled, decoded video data can then pass to an encoder 198, which can include a DCT coder, a quantizer 76 and a variable-length encoder (VLC). In turn, the encoder can be capable of re-encoding the video data at the reduced bit rate.

As shown in FIG. 7, a transcoder 200 of yet another alternative embodiment of the present invention can be configured in much the same manner as the arrangement of FIG. 6, including a reduced-resolution decoder 202, a downsampler 204 and an encoder 206. In this regard, like the transcoder 192 shown in the embodiment of FIG. 6, the reduced-resolution decoder of the transoder of FIG. 7 is capable of decoding macroblocks of video data in the spatial domain, while effectively downsampling the video data in the horizontal direction. The downsampler of the transcoder of FIG. 7, again, like the downsampler of the transcoder of FIG. 6, can be capable of vertically downsampling the decoded macroblocks, and thereafter passing the downsampled, decoded macroblocks to the encoder, which can be capable of re-encoding the video data at the reduced bit rate. In contrast to the embodiment shown in FIG. 6, however, the transcoder of FIG. 7 further includes a motion vector (MV) mapping element 208. The MV mapping element, in turn, is capable of passing the motion vectors from the reduced-resolution decoder to the encoder to thereby avoid, or at least simplify, motion estimation in the encoder.

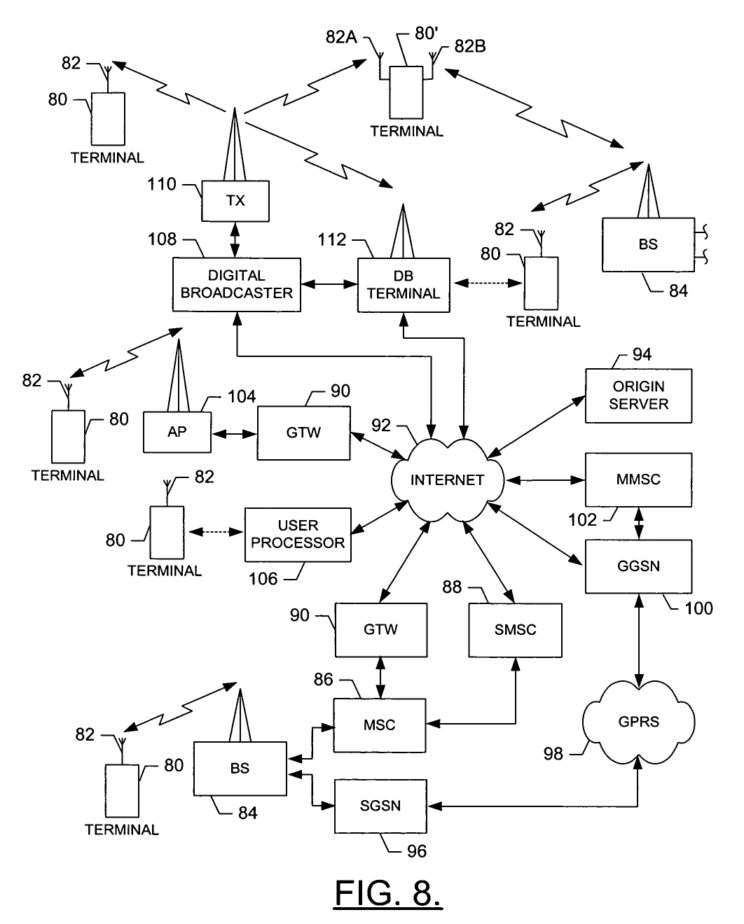

Reference is now made to FIG. 8, which illustrates one type of terminal and system that would benefit from the transcoder 50 of embodiments of the present invention. As shown, the transcoder of embodiments of the present invention provides particular advantages in mobile communications applications that may have limited processing and/or memory resources. It should be understood, however, that the transcoder of embodiments of the present invention can be utilized in conjunction with a variety of other applications, both in the mobile communications industries and outside of the mobile communications industries. For example, the transcoder of embodiments of the present invention can be utilized in conjunction with wireline and/or wireless network (e.g., Internet) applications. Also, whereas the transcoder can be implemented in software capable of being stored within memory of a processing device and operated by a processor, it should be understood that the transcoder can alternatively comprise firmware or hardware, without departing from the spirit and scope of the present invention.

As shown, a terminal 80 may include an antenna 82 for transmitting signals to and for receiving signals from a base site or base station (BS) 84. The base station is a part of one or more cellular or mobile networks that each include elements required to operate the network, such as a mobile switching center (MSC) 86. As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also control the forwarding of messages for the terminal to and from a messaging center, such as short messaging service (SMS) messages to and from a SMS center (SMSC) 88.

The MSC 86 can be coupled to a data network, such as a local area network (LAN), a metropolitan area network (MAN), and/or a wide area network (WAN). The MSC can be directly coupled to the data network. In one typical embodiment, however, the MSC is coupled to a GTW 90, and the GTW is coupled to a WAN, such as the Internet 92. In turn, devices such as processing elements (e.g., personal computers, server computers or the like) can be coupled to the terminal 80 via the Internet. For example, as explained below, the processing elements can include one or more processing elements associated with an origin server 94 or the like, one of which being illustrated in FIG. 8.

The BS 84 can also be coupled to a signaling GPRS (General Packet Radio Service) support node (SGSN) 96. As known to those skilled in the art, the SGSN is typically capable of performing functions similar to the MSC 86 for packet switched services. The SGSN, like the MSC, can be coupled to a data network, such as the Internet 92. The SGSN can be directly coupled to the data network. In a more typical embodiment, however, the SGSN is coupled to a packet-switched core network, such as a GPRS core network 98. The packet-switched core network is then coupled to another GTW, such as a GTW GPRS support node (GGSN) 100, and the GGSN is coupled to the Internet. In addition to the GGSN, the packet-switched core network can also be coupled to a GTW 90. Also, the GGSN can be coupled to a messaging center, such as a multimedia messaging service (MMS) center 102. In this regard, the GGSN and the SGSN, like the MSC, can be capable of controlling the forwarding of messages, such as MMS messages. The GGSN and SGSN can also be capable of controlling the forwarding of messages for the terminal to and from the messaging center.

In addition, by coupling the SGSN 96 to the GPRS core network 98 and the GGSN 100, devices such as origin servers 94 can be coupled to the terminal 80 via the Internet 92, SGSN and GGSN. In this regard, devices such as origin servers can communicate with the terminal across the SGSN, GPRS and GGSN. For example, origin servers can provide content to the terminal, such as in accordance with the Multimedia Broadcast Multicast Service (MBMS). For more information on the MBMS, see Third Generation Partnership Project (3GPP) technical specification 3GPP TS 22.146, entitled: Multimedia Broadcast Multicast Service (MBMS), the contents of which are hereby incorporated by reference in its entirety.

Although not every element of every possible mobile network is shown and described herein, it should be appreciated that the terminal 80 can be coupled to one or more of any of a number of different networks through the BS 84. In this regard, the network(s) can be capable of supporting communication in accordance with any one or more of a number of first-generation (IG), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The terminal 80 can further be coupled to one or more wireless access points (APs) 104. The APs can comprise access points configured to communicate with the terminal in accordance with techniques such as, for example, radio frequency (RF), Bluetooth (BT), infrared (IrDA) or any of a number of different wireless networking techniques, including WLAN techniques. Additionally, or alternatively, the terminal can be coupled to one or more user processors 106. Each user processor can comprise a computing system such as personal computers, laptop computers or the like. In this regard, the user processors can be configured to communicate with the terminal in accordance with techniques such as, for example, RF, BT, IrDA or any of a number of different wireline or wireless communication techniques, including LAN and/or WLAN techniques. One or more of the user processors can additionally, or alternatively, include a removable memory capable of storing content, which can thereafter be transferred to the terminal.

The APs 104 and the workstations 106 may be coupled to the Internet 92. Like with the MSC 86, the APs and workstations can be directly coupled to the Internet. In one advantageous embodiment, however, the APs are indirectly coupled to the Internet via a GTW 90. As will be appreciated, by directly or indirectly connecting the terminals and the origin server 94, as well as any of a number of other devices, to the Internet, the terminals can communicate with one another, the origin server, etc., to thereby carry out various functions of the terminal, such as to transmit data, content or the like to, and/or receive content, data or the like from, the origin server. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Further, the terminal 80 can additionally, or alternatively, be coupled to any of a number of broadcast and/or multicast networks. For example, the terminal can be coupled to a digital video broadcasting network. As will be appreciated, for example, such a digital video broadcasting network can support communications in accordance with the Digital Video Broadcasting (DVB) standard and/or variants of the DVB standard, including DVB-T (terrestrial), DVB-MHP (multimedia home platform), DVB-H (handheld), DVB-C (cable), DVB-S (satellite) and/or DVB-IP. Further, for example, such a digital video broadcasting network can additionally or alternatively support communications in accordance with the Data Over Cable Service Interface Specification (DOCSIS), Japanese Terrestrial Integrated Service Digital Broadcasting (ISDB-T), Digital Audio Broadcasting (DAB), and MBMS, and those networks provided by the Advanced Television Systems Committee (ATSC).

In many such broadcasting networks, a containerization technique is utilized in which content for transmission is placed into MPEG-2 packets which act as data containers. Thus, the containers can be utilized to transport any suitably digitized data including, but not limited to High Definition TV, multiple channel Standard Definition TV (PAUNTSC or SECAM) and, of course, broadband multimedia data and interactive services. DVB-T, for example, is a wireless point-to-multipoint data delivery mechanism developed for digital TV broadcasting, and is based on the MPEG-2 transport stream for the transmission of video and synchronized audio. As will be appreciated by those skilled in the art, DVB-T also has the capability of efficiently transmitting large amounts of data over a broadcast channel to a high number of users at a lower cost, when compared to data transmission through mobile telecommunication networks using, e.g., 3G systems. Advantageously, DVB-T has further proven to be exceptionally robust in that it provides increased performance in geographic conditions that would normally affect other types of transmissions, such as the rapid changes of reception conditions, and hilly and mountainous terrain. On the other hand, other variations of this DVB-T are being developed to account for the capabilities of handheld devices (e.g., terminals 80), such as the power consumption of such devices.

More particularly, for example, the terminal can be coupled to a digital video broadcasting (e.g., DVB-T, DVB-H, ISDB-T, ATSC, etc.) network. As will be appreciated, by directly or indirectly connecting the terminals and a digital broadcaster 108 of the digital video broadcasting network, the terminals can receive content, such as content for one or more television, radio and/or data channels, from the digital broadcaster. In this regard, the digital broadcaster can include, or be coupled to, a transmitter (TX) 110, such as a DVB-T TX. Similarly, the terminal can include a receiver, such as a DVB-T receiver (not shown). The terminal can be capable of receiving content from any of a number of different entities in any one or more of a different number of manners. In one embodiment, for example, the terminal can comprise a terminal 80′ capable of transmitting and/or receiving data, content or the like in accordance with a DVB (e.g., DVB-T, DVB-H, etc.) technique as well as a mobile (e.g., 1G, 2G, 2.5G, 3G, etc.) communication technique. In such an embodiment, the terminal 80′ may include an antenna 82A for receiving content from the DVB-T TX, and another antenna 82B for transmitting signals to and for receiving signals from a BS 84. For more information on such a terminal, see U.S. patent application Ser. No. 09/894,532, entitled: Receiver, filed Jun. 29, 2001, the contents of which is incorporated herein by reference in its entirety.

In addition to, or in lieu of, directly coupling the terminal 80 to the digital broadcaster 108 via the TX 110, the terminal can be coupled to a digital broadcast (DB) receiving terminal 112 which, in turn, can be coupled to the digital broadcaster 32, such as directly and/or via the TX. In such instances, the digital broadcast receiving terminal can comprise a DVB-T receiver, such as a DVB-T receiver in the form of a set top box. The terminal can be locally coupled to the digital broadcast receiving terminal, such as via a personal area network. In one advantageous embodiment, however, the terminal can additionally or alternatively be indirectly coupled to the digital broadcast receiving terminal via the Internet 92.

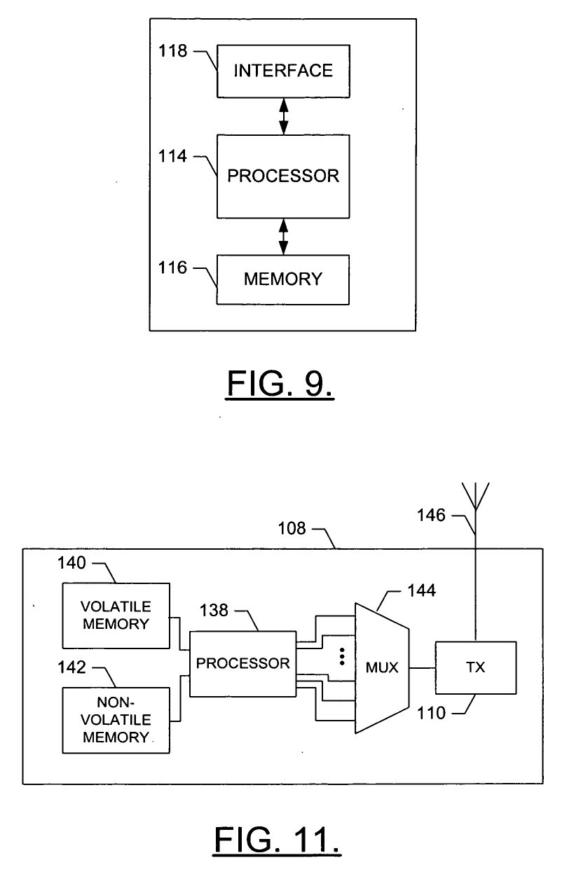

As will be appreciated, at one or more instances, two or more network entities, such as those shown in FIG. 8, can be capable of communicating with one another, such as to transmit and/or receive video data. In such instances, it may be desirable to transcode the video data from one format into another format before or after transmission. In other instances, it may be desirable to transcode video data for local use by the network entity transcoding the video data. Thus, any one or more of the entities of the system shown in FIG. 8 can include, or otherwise be capable of implementing, the transcoder 50 of embodiments of the present invention. By including, or otherwise being capable of implementing, the transcoder of embodiments of the present invention, the entities can be capable of transcoding video data before the respective entities transmit the video data, or after the respective entities receive the video data. Reference will now be made to FIGS. 9-12, which more particularly illustrate various entities of the system shown in FIG. 1 for purposes of example.

Referring now to FIG. 9, a block diagram of an entity capable of operating as a terminal 80, origin server 94, user processor 106, digital broadcast receiving terminal 112, and/or a digital broadcaster 108 is shown in accordance with one embodiment of the present invention. Although shown as separate entities, in some embodiments, one or more entities may support one or more of a terminal, origin server, digital broadcast receiving terminal, and/or a digital broadcaster, logically separated but co-located within the entit(ies). For example, a single entity may support a logically separate, but co-located, terminal and digital broadcast receiving terminal. Also, for example, a single entity may support a logically separate, but co-located digital broadcast receiving terminal and digital broadcaster.

As shown, the entity capable of operating as a terminal 80, origin server 94, user processor 106, digital broadcast receiving terminal 112, and/or a digital broadcaster 108 can generally include a processor 114 connected to a memory 116. The processor can also be connected to at least one interface 118 or other means for transmitting and/or receiving data, content or the like. The memory can comprise volatile and/or non-volatile memory, and typically stores content, data or the like. For example, the memory typically stores software applications, instructions or the like for the processor to perform steps associated with operation of the entity in accordance with embodiments of the present invention. In this regard, the memory can be capable of storing software applications, instructions or the like for the processor to implement the transcoder 50. Also, for example, the memory typically stores data, such as video data, transmitted from, or received by, the terminal, digital broadcast receiving terminal, and/or digital broadcaster.

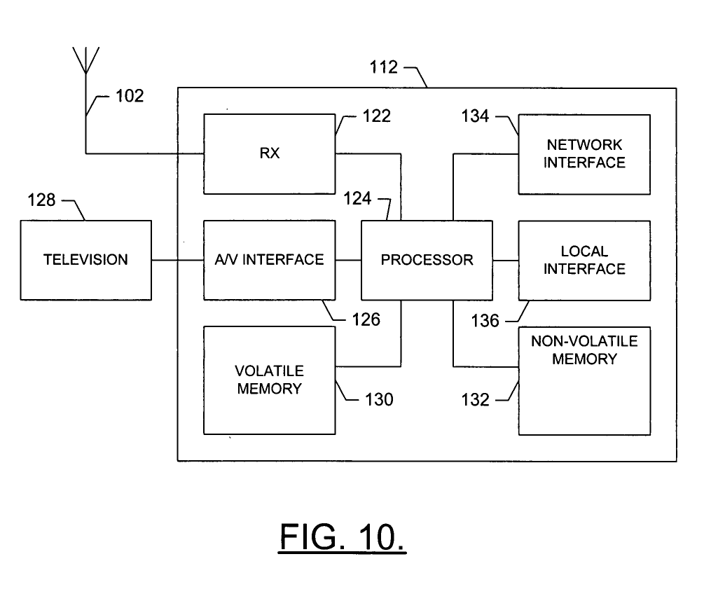

Reference is now made to FIG. 10, which illustrates a functional block diagram of a digital broadcast receiving terminal 112, in accordance with one embodiment of the present invention. As shown, the digital broadcast receiving terminal includes an antenna 44 for receiving signals from a digital broadcaster 108 and feeding the signals into a receiver (RX) 122. In turn, the receiver is capable of decrypting, demodulating and/or demultiplexing the signals, such as to extract content data. The receiver can feed the content data to a processor 124, which can thereafter decode the content data. In addition, the processor can implement the transcoder 50 to thereby transcode content data comprising video data, such as for subsequent transmission to other electronic devices. The processor can then feed the signal into an audio/video (A/V) interface 126, which can convert signals to a form suitable for display by a monitor, such as a television set 128.

The digital broadcast receiving terminal 112 can include volatile memory 130, such as volatile Random Access Memory (RAM) including a cache area for the temporary storage of data. The digital broadcast receiving terminal can also include non-volatile memory 130, which can be embedded and/or may be removable. The non-volatile memory can additionally or alternatively comprise an EEPROM, flash memory, hard disk or the like. The memories can store any of a number of pieces of information, content and data, used by the digital broadcast receiving terminal to implement the functions of the digital broadcast receiving terminal. For example, the memories can store software applications, instructions or the like for the processor 124 to implement the transcoder 50.

The digital broadcast receiving terminal 112 can also include one or more interface means for sharing and/or obtaining data from electronic devices, such as terminals 80 and/or digital broadcasters 108. More particularly, the digital broadcast receiving terminal can include a network interface means 134, for sharing and/or obtaining data from a network, such as the Internet 92. For example, the network interface means can include an Ethernet Personal Computer Memory Card International Association (PCMCIA) card configured to transmit data to and/or receive data from a network, such as the Internet.

The digital broadcast receiving terminal 112 can also include one or more local interface means 136 for locally sharing and/or obtaining data from electronic devices, such as a terminal. For example, the digital broadcast receiving terminal can include a radio frequency transceiver and/or an infrared (1R) transceiver so that data can be shared with and/or obtained in accordance with radio frequency and/or infrared transfer techniques. Additionally, or alternatively, for example, the digital broadcast receiving terminal can include a Bluetooth (BT) transceiver operating using Bluetooth brand wireless technology developed by the Bluetooth Special Interest Group such that the digital broadcast receiving terminal can share and/or obtain data in accordance with Bluetooth transfer techniques. Further, the digital broadcast receiving terminal can additionally or alternatively be capable of sharing and/or obtaining data in accordance with any of a number of different wireline and/or wireless networking techniques, including LAN and/or WLAN techniques.

Reference is now made to FIG. 11, which illustrates a functional block diagram of the digital broadcaster 108 of one embodiment of the present invention. Like the digital broadcast receiving terminal 112, the digital broadcaster can include a processor 138 capable of carrying out the functions of the digital broadcaster. The digital broadcaster can also include a volatile memory 140, such as volatile Random Access Memory (RAM) including a cache area for the temporary storage of data. The digital broadcaster can also include non-volatile memory 142, which can be embedded and/or may be removable. The non-volatile memory can additionally or alternatively comprise an EEPROM, flash memory, hard disk or the like. The memories can store any of a number of pieces of information, content and data, used by the digital broadcaster to implement the functions of the digital broadcaster. For example, as indicated above, the memories can store content, such as content for a television channel and other content for a number of other television, radio and/or data channels. Also, for example, the memories can store software applications, instructions or the like for the processor to implement the transcoder 50.

The digital broadcaster 108 can also include a multiplexer 144, which can be capable of multiplexing content for a number of television, radio and/or data channels. The multiplexer can then feed the resulting signal into a TX 110, which can be separate from the digital broadcaster, as shown in FIG. 1, or incorporated within the digital broadcaster, as shown in FIG. 11. Irrespective of where the TX is located relative to the digital broadcaster, the TX can receive the signal from the multiplexer for encryption, modulation, amplification and/or transmission, such as via an antenna 146. In this regard, for example, the digital broadcaster can be capable of directly or indirectly transmitting content to a digital broadcast receiving terminal 112 and/or a terminal 80, such as in accordance with a digital broadcasting technique, such as DVB-T. For information on DVB-T, see European Telecommunications Standards Institute (ETSI) Standard EN 300 744, entitled: Digital Video Broadcasting (DVB): Framing structure, channel coding and modulation for digital terrestrial television, v.1.1.2 (1997) and related specifications, the contents of which are hereby incorporated by reference in their entirety.

In accordance with a number of digital broadcasting techniques, such as DVB-T, Internet Protocol (IP) Datacast (IPDC) can be utilized to provide audio, video and/or other content to terminals 80. In this regard, the digital broadcaster 108 can be capable of providing IP datacasting content to the terminal utilizing a digital broadcasting technique. As will be appreciated by those skilled in the art, digital broadcasting techniques such as DVB-T are essentially mobile in nature with a transmission site associated with each of a number of different cells. DVB-T, for example, uses MPEG-2 transport streams, and as such, IP data can be encapsulated into DVB transmission signals sent from the digital broadcaster, or more particularly the TX 110. Data streams including IP datagrams can be supplied from several sources, and can be encapsulated by an IP encapsulator (not shown). The IP encapsulator, in turn, can feed the encapsulated IP data streams into the data broadcasting (e.g., DVB-T) network.

The encapsulated IP data streams can then be transported to one or more transmission sites, where the transmission sites form cells of the data broadcasting network. For example, the encapsulated IP data streams can be transported to one or more transmission sites on an MPEG-2 transport stream for subsequent transmission over the air directly to the terminals, or to a receiver station serving one or more terminals. As will be appreciated, the MPEG-2 transport stream, from production by the IP encapsulator, to reception by the terminals or the receiver station, is typically uni-directional in nature. In this regard, IP packets containing the data can be embedded in multi-protocol encapsulation (MPE) sections that are transported within transport stream packets.

In addition to the IP packets, the MPE sections can also include forward error correction (FEC) information and time slicing information. By including information such as time slicing information, data can be conveyed discontinuously with the receiver (e.g., terminal 80), being capable of saving battery power by switching off when no data is being transmitted to the receiver. In other terms, in accordance with one time slicing technique, instead of using the current default method of continuous digital broadcasting (e.g., DVB-T) transmission, a time division multiplex-type of allocation technique can be employed (see, e.g., DVB-H standard). With such an approach, then, services can be provided in bursts, allowing a receiver to power down when the receiver is not receiving data, and allowing the receiver to power up to receive data packets, as necessary.

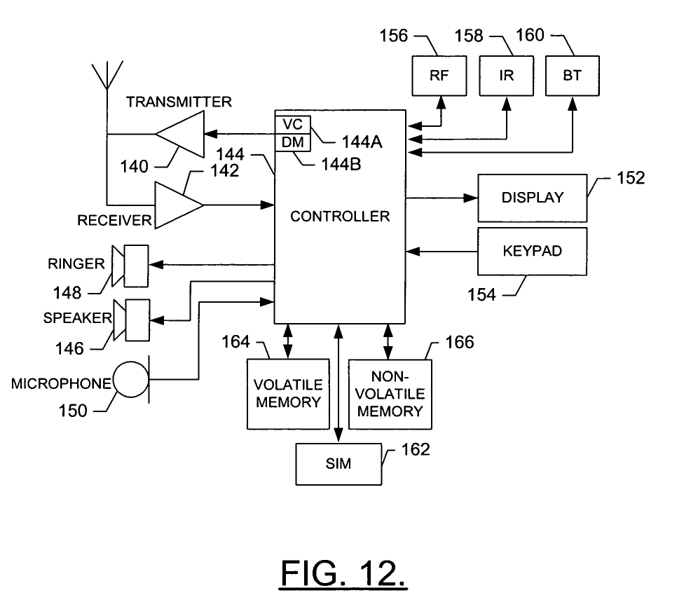

FIG. 12 illustrates a functional diagram of a mobile station that may operate as a terminal 80, according to embodiments of the invention. It should be understood, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 140, a receiver 142, and a controller 144 that provides signals to and receives signals from the transmitter and receiver, respectively. These signals include signaling information in accordance with the air interface standard of the applicable mobile system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, Enhanced Data GSM Environment (EDGE), or the like. The mobile station can additionally or alternatively be capable of operating in accordance with any of a number of different digital broadcasting techniques, such as the DVB technique (e.g., DVB-T, ETSI Standard EN 300 744). The mobile station can also be capable of operating in accordance with any of a number of different broadcast and/or multicast techniques, such as the MBMS technique (e.g., 3GPP TS 22.146). Further, the mobile station can be capable of operating in accordance with ISDB-T, DAB, ATSC techniques or the like. Some narrow-band AMPS (NAMPS), as well as TACS, mobile stations may also benefit from embodiments of the present invention, as should dual or higher mode mobile stations (e.g., digital/analog or TDMA/CDMA/analog phones).

It is understood that the controller 144 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 144A, and may include an internal data modem (DM) 144B.

Further, the controller may include the functionality to operate one or more software applications, which may be stored in memory.

The mobile station also comprises a user interface including a conventional earphone or speaker 146, a ringer 148, a microphone 150, a display 152, and a user input interface, all of which are coupled to the controller 144. The user input interface, which allows the mobile station to receive data, can comprise any of a number of devices allowing the mobile station to receive data, such as a keypad 154, a touch display (not shown) or other input device. In embodiments including a keypad, the keypad includes the conventional numeric (0-9) and related keys (#, *), and other keys used for operating the mobile station.

The mobile station can also include one or more means for sharing and/or obtaining data from electronic devices, such as another terminal 80, an origin server 94, an AP 104, a digital broadcast receiving terminal 112, a digital broadcaster 108, a user processor 106 or the like, in accordance with any of a number of different wireline and/or wireless techniques. For example, the mobile station can include a radio frequency (RF) transceiver 156 and/or an infrared (1R) transceiver 158 such that the mobile station can share and/or obtain data in accordance with radio frequency and/or infrared techniques. Also, for example, the mobile station can include a Bluetooth (BT) transceiver 160 such that the mobile station can share and/or obtain data in accordance with Bluetooth transfer techniques. Although not shown, the mobile station may additionally or alternatively be capable of transmitting and/or receiving data from electronic devices according to a number of different wireline and/or wireless networking techniques, including LAN and/or WLAN techniques. In this regard, as shown in FIG. 1 with respect to terminal 80′, the mobile station may include an additional antenna or the like to transmit and/or receive data from such electronic devices (e.g., digital broadcaster).

The mobile station can further include memory, such as a subscriber identity module (SIM) 162, a removable user identity module (R-UIM) or the like, which typically stores information elements related to a mobile subscriber. In addition to the SIM, the mobile station can include other memory. In this regard, like the digital broadcast receiving terminal 112 and the digital broadcaster 108, the mobile station can include volatile memory 164. Also, again like the digital broadcast receiving terminal and the digital broadcaster, the mobile station can include other non-volatile memory 166, which can be embedded and/or may be removable. For example, the other non-volatile memory can comprise embedded or removable multimedia memory cards (MMC's), Memory Sticks manufactured by Sony Corporation, EEPROM, flash memory, hard disk or the like.

The memories 162, 164, 166 can store any of a number of pieces of information, and data, used by the mobile station to implement the functions of the mobile station. For example, the memories can store an identifier, such as an international mobile equipment identification (IMEI) code, international mobile subscriber identification (IMSI) code, mobile station integrated services digital network (MSISDN) code or the like, capable of uniquely identifying the mobile station, such as to the MSC 86. The memories can also store data, such as video data received from an origin server 94 and/or a digital broadcast receiving terminal 112. Also, for example, the memories can store one or more presentation applications such as a conventional text viewer, audio player, video player, multimedia viewer or the like. In addition, as with the other entities illustrated herein, the memories can store software applications, instructions or the like for the processor 124 to implement the transcoder 50.

According to one aspect of the present invention, all or a portion of the system of the present invention, such as all or portions of terminal 80, origin server 94, user processor 106, digital broadcast receiving terminal 112, and/or a digital broadcaster 108, generally operates under control of a computer program product (e.g., transcoder 50). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIG. 5 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart supports combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A transcoder for transcoding data comprising a group of macroblocks representing a frame of data, the transcoder comprising:
a decoder capable of decoding input data to thereby generate prediction error and decoded image data in a spatial domain;
a downsampler capable of downsampling one of the prediction error and the decoded image data in at least one of a first direction and a second direction different than the first direction to generate a downsampled macroblock in the spatial domain; and
an encoder capable of encoding the downsampled macroblock into output data.

2. A transcoder according to claim 1, wherein the decoder comprises:
a variable-length decoder capable of variable-length decoding input data to generate quantized Discrete Cosine Transform (DCT) coefficients;
an inverse quantizer capable of inverse quantizing the quantized DCT coefficients to generate DCT coefficients;
an inverse DCT-coder capable of inverse DCT-coding the DCT coefficients to generate the prediction error in the spatial domain; and
a summing element capable of summing the residual blocks and motion compensation data to generate the decoded image data.

3. A transcoder according to claim 1, wherein the decoder is capable of decoding the input data at a reduced resolution.

4. A transcoder according to claim 3, wherein the decoder is capable of decoding the input data further including downsampling the input data, including the prediction error and the decoded image data, in the first direction, and wherein the downsampler is capable of downsampling one of the prediction error and the decoded image data in the second direction in the spatial domain.

5. A transcoder according to claim 1 further comprising:
an intra/inter selector capable of determining to pass to the downsampler and encoder one of the prediction error and the decoded image data based upon at least one of coding, motion vectors and residual energy of the macroblocks of the group of macroblocks.

6. A transcoder according to claim 1, wherein the encoder comprises:
a Discrete Cosine Transform (DCT)-coder capable of DCT-coding the downsampled macroblock into DCT coefficients in a DCT domain;
a quantizer capable of quantizing the DCT coefficients; and
a variable-length encoder capable of variable-length coding the DCT coefficients into output data.

7. A transcoder according to claim 1, wherein the frame of data comprises a plurality of sample lines each comprising a plurality of samples, and wherein the downsampler is capable of downsampling one of the prediction error and the decoded image data in the second direction by skipping one of a top and a bottom field of the frame of data when the data comprises interlaced data, and skipping every other sample line of the frame of data when the data comprises non-interlaced data.

8. A transcoder according to claim 1, wherein the frame of data comprises a plurality of sample lines each comprising a plurality of samples, and wherein the downsampler is capable of downsampling one of the prediction error and the decoded image data in the first direction by one of skipping every other sample of each sample line of the frame of data and averaging every pair of neighboring samples of each sample line.

9. A transcoder for transcoding data comprising a group of macroblocks representing a frame of data, the transcoder comprising:
a reduced-resolution decoder capable of decoding input data to thereby generate decoded image data at a reduced resolution and downsample the input data in a first direction;
a downsampler capable of downsampling the decoded image data in a second direction different than the first direction to generate a downsampled macroblock; and
an encoder capable of encoding the downsampled macroblock into output data.

10. A transcoder according to claim 9, wherein the decoder capable of decoding input data to thereby generate the decoded image data in a spatial domain and a prediction error in the spatial domain, and wherein the downsampler is capable of downsampling one of the prediction error and the decoded image data to generate the downsampled macroblock.

11. A transcoder according to claim 10 further comprising:
an intra/inter selector capable of determining to pass to the downsampler and encoder one of the prediction error and the decoded image data based upon at least one of coding, motion vectors and residual energy of the macroblocks of the group of macroblocks.

12. A transcoder according to claim 9 further comprising:
a mixed block processor capable of converting at least one of the macroblocks of the decoded image data from a first coding mode to a second coding mode before the downsampler downsamples the decoded image data.

13. A system of transcoding data comprising a group of macroblocks representing a frame of data, the system comprising:
a network entity capable of decoding input data to thereby generate prediction error and decoded image data in a spatial domain, wherein the network entity is also capable of downsampling one of the prediction error and the decoded image data in at least one of a first direction and a second direction different than the first direction to generate a downsampled macroblock in the spatial domain, and wherein the network entity is capable of encoding the downsampled macroblock into output data.

14. A system according to claim 13, wherein the network entity is capable of decoding the input data by variable-length decoding input data to generate quantized Discrete Cosine Transform (DCT) coefficients, inverse quantizing the quantized DCT coefficients to generate DCT coefficients, inverse DCT-coding the DCT coefficients to generate the prediction error in the spatial domain, and thereafter summing the residual blocks and motion compensation data to generate the decoded image data.

15. A system according to claim 13, wherein the network entity is capable of decoding the input data at a reduced resolution.

16. A system according to claim 15, wherein the network entity is capable of decoding the input data further including downsampling the input data, including the prediction error and the decoded image data, in the first direction, and wherein the network entity is capable of downsampling one of the prediction error and the decoded image data in the second direction in the spatial domain.

17. A system according to claim 13, wherein the network entity is capable of determining to downsample and encode one of the prediction error and the decoded image data based upon at least one of coding, motion vectors and residual energy of the macroblocks of the group of macroblocks.

18. A system according to claim 13, wherein the network entity is capable of encoding the downsampled macroblock by Discrete Cosine Transform (DCT)-coding the downsampled one of the residual block and the decoded macroblock into DCT coefficients in a DCT domain, quantizing the DCT coefficients, and thereafter variable-length coding the DCT coefficients into output data.

19. A system according to claim 13, wherein the frame of data comprises a plurality of sample lines each comprising a plurality of samples, and wherein the network entity is capable of downsampling one of the prediction error and the decoded image data in the second direction by one of skipping one of a top and a bottom field of the frame of data when the data comprises interlaced data, and skipping every other sample line of the frame of data when the data comprises non-interlaced data.

20. A system according to claim 13, wherein the frame of data comprises a plurality of sample lines each comprising a plurality of samples, and wherein the network entity is capable of downsampling one of the prediction error and the decoded image data in the first direction by one of skipping every other sample of each sample line of the frame of data and averaging every pair of neighboring samples of each sample line.

21. A system of transcoding data comprising a group of macroblocks representing a frame of data, the system comprising:
a network entity capable of decoding input data to thereby generate decoded image data at a reduced resolution and downsample the input data in a first direction, wherein the network entity is also capable of downsampling the decoded image data in a second direction different than the first direction to generate a downsampled macroblock, and wherein the network entity is capable of encoding the downsampled macroblock into output data.

22. A system according to claim 21, wherein the network entity is capable of decoding input data to thereby generate the decoded image data in a spatial domain and a prediction error in the spatial domain, and wherein the network entity is capable of downsampling one of the prediction error and the decoded image data to generate the downsampled macroblock.

23. A system according to claim 22, wherein the network entity is further capable of downsampling and encoding one of the prediction error and the decoded image data based upon at least one of coding, motion vectors and residual energy of the macroblocks of the group of macroblocks.

24. A system according to claim 21, wherein the network entity is further capable of converting at least one of the macroblocks of the decoded image data from a first coding mode to a second coding mode before the downsampling the decoded image data.

25. A method of transcoding data comprising a group of macroblocks representing a frame of data, the method comprising:
decoding input data, wherein decoding input data comprises generating prediction error and decoded image data in a spatial domain;
downsampling one of the prediction error and the decoded image data in at least one of a first direction and a second direction different than the first direction, wherein downsampling comprises downsampling in the spatial domain to generate a downsampled macroblock in the spatial domain; and
encoding the downsampled macroblock into output data.

26. A method according to claim 25, wherein decoding input data comprises:
variable-length decoding input data to generate quantized Discrete Cosine Transform (DCT) coefficients;
inverse quantizing the quantized DCT coefficients to generate DCT coefficients;
inverse DCT-coding the DCT coefficients to generate the prediction error in the spatial domain; and
summing the residual blocks and motion compensation data to generate the decoded image data.

27. A method according to claim 25, wherein decoding input data comprises decoding input data at a reduced resolution.

28. A method according to claim 27, wherein decoding input data further comprises downsampling the input data, including the prediction error and the decoded image data, in the first direction, and wherein downsampling comprises downsampling one of the prediction error and the decoded image data in the second direction in the spatial domain.

29. A method according to claim 25 further comprising:
determining to downsample and encode one of the prediction error and the decoded image data based upon at least one of coding, motion vectors and residual energy of the macroblocks of the group of macroblocks.

30. A method according to claim 25, wherein encoding the downsampled macroblock comprises:
Discrete Cosine Transform (DCT)-coding the downsampled macroblock into DCT coefficients in a DCT domain;
quantizing the DCT coefficients; and
variable-length coding the DCT coefficients into output data.

31. A method according to claim 25, wherein the frame of data comprises a plurality of sample lines each comprising a plurality of samples, and wherein downsampling one of the prediction error and the decoded image data in the second direction comprises one of skipping one of a top and a bottom field of the frame of data when the data comprises interlaced data, and skipping every other sample line of the frame of data when the data comprises non-interlaced data.

32. A method according to claim 25, wherein the frame of data comprises a plurality of sample lines each comprising a plurality of samples, and wherein downsampling one of the prediction error and the decoded image data in the first direction comprises one of skipping every other sample of each sample line of the frame of data and averaging every pair of neighboring samples of each sample line.

33. A method of transcoding data comprising a group of macroblocks representing a frame of data, the method comprising:
decoding input data to thereby generate decoded image data at a reduced resolution and downsample the input data in a first direction;
downsampling the decoded image data in a second direction different than the first direction to generate a downsampled macroblock; and
encoding the downsampled macroblock into output data.

34. A method according to claim 33, wherein decoding input data comprises decoding input data to thereby generate the decoded image data in a spatial domain and a prediction error in the spatial domain, and wherein downsampling the decoded image data comprises downsampling one of the prediction error and the decoded image data to generate the downsampled macroblock.

35. A method according to claim 34 further comprising:
determining to downsample and encode one of the prediction error and the decoded image data based upon at least one of coding, motion vectors and residual energy of the macroblocks of the group of macroblocks.

36. A method according to claim 33 further comprising:
converting at least one of the macroblocks of the decoded image data from a first coding mode to a second coding mode before downsampling the decoded image data.

37. A computer program product for transcoding data comprising a group of macroblocks representing a frame of data, the computer program product comprising a computer-readable storage medium having computer-readable program code portions stored therein, the computer-readable program code portions comprising:
a first executable portion for decoding input data, wherein the first executable portion is adapted to generate prediction error and decoded image data in a spatial domain;
a second executable portion for downsampling one of the prediction error and the decoded image data in at least one of a first direction and a second direction different than the first direction, wherein the second executable portion is adapted to downsample in the spatial domain to generate a downsampled macroblock in the spatial domain; and
a third executable portion for encoding the downsampled macroblock into output data.

38. A computer program product according to claim 37, wherein the first executable portion is adapted to variable-length decode input data to generate quantized Discrete Cosine Transform (DCT) coefficients, inverse quantize the quantized DCT coefficients to generate DCT coefficients, inverse DCT-code the DCT coefficients to generate the prediction error in the spatial domain, and thereafter sum the residual blocks and motion compensation data to generate the decoded image data.

39. A computer program product according to claim 37, wherein the first executable portion is adapted to decode the input data at a reduced resolution.

40. A computer program product according to claim 39, wherein the first executable portion is further adapted to downsample the input data, including the prediction error and the decoded image data, in the first direction, and wherein the first executable portion is adapted to downsample one of the prediction error and the decoded image data in the second direction in the spatial domain.

41. A computer program product according to claim 37 further comprising:
a fourth executable portion for determining to downsample and encode one of the prediction error and the decoded image data based upon at least one of coding, motion vectors and residual energy of the macroblocks of the group of macroblocks.

42. A computer program product according to claim 37, wherein the third executable portion is adapted to Discrete Cosine Transform (DCT)-code the downsampled macroblock into DCT coefficients in a DCT domain, quantize the DCT coefficients, and thereafter variable-length code the DCT coefficients into output data.

43. A computer program product according to claim 37, wherein the frame of data comprises a plurality of sample lines each comprising a plurality of samples, and wherein the second executable portion is adapted to downsample one of the prediction error and the decoded image data in the second direction by one of skipping one of a top and a bottom field of the frame of data when the data comprises interlaced data, and skipping every other sample line of the frame of data when the data comprises non-interlaced data.

44. A computer program product according to claim 37, wherein the frame of data comprises a plurality of sample lines each comprising a plurality of samples, and wherein the second executable portion is adapted to downsample one of the prediction error and the decoded image data in the first direction by one of skipping every other sample of each sample line of the frame of data and averaging every pair of neighboring samples of each sample line.

45. A computer program product for transcoding data comprising a group of macroblocks representing a frame of data, the computer program product comprising a computer-readable storage medium having computer-readable program code portions stored therein, the computer-readable program code portions comprising:
a first executable portion for decoding input data to thereby generate decoded image data at a reduced resolution and downsample the input data in a first direction;
a second executable portion for downsampling the decoded image data in a second direction different than the first direction to generate a downsampled macroblock; and
a third executable portion for encoding the downsampled macroblock into output data.

46. A computer program product according to claim 45, wherein the first executable portion is adapted to decode input data to thereby generate the decoded image data in a spatial domain and a prediction error in the spatial domain, and wherein the second executable portion is adapted to downsample one of the prediction error and the decoded image data to generate the downsampled macroblock.

47. A computer program product according to claim 46 further comprising:
a fourth executable portion for determining to downsample and encode one of the prediction error and the decoded image data based upon at least one of coding, motion vectors and residual energy of the macroblocks of the group of macroblocks.

48. A computer program product according to claim 45 further comprising:
a fourth executable portion for converting at least one of the macroblocks of the decoded image data from a first coding mode to a second coding mode before downsampling the decoded image data.
